(19) United States
(12) Patent Application Publication
(10) Pub. No.: US 2014/0018944 A1
(43) Pub. Date: Jan. 16, 2014

(54) METHOD AND SYSTEM FOR MEASURING PLURALITY OF GROUPED ELAPSED TIMES

(71) Applicants: Dong Gil Ko, Loveland, OH (US); Jee-young Choi, Loveland, OH (US)

(72) Inventors: Dong Gil Ko, Loveland, OH (US); Jee-young Choi, Loveland, OH (US)

(21) Appl. No.: 13/547,032

(22) Filed: Jul. 11, 2012

(51) Int. Cl. G06F 19/00

(52) U.S. Cl. 700/91

(57) ABSTRACT

There is described a method and system of measuring, displaying, recording, and storing real-time elapsed times for each athlete to complete predetermined distances or repetitions having multiple athletes within a heat who have common starting time and different stopping times with each heat having different starting times. Trainers use a personal or mobile communication device to measure, display, record, and store elapsed times for each repetition completed by each athlete as well as to create, modify, delete, and display athlete, benchmark set, elapsed time, body count, and power tower data. A software application provides athlete assignments to a heat and a lane, benchmark set selection, timer initiation, and elapsed time measurement, display, recording, and storage for each repetition completed by each athlete. It further provides the user the ability to upload and download data from and to a storage location as well as to perform text or email communications.

### FIELD OF THE INVENTION

The present invention relates to athletic timing, and more specifically to a method and system for measuring elapsed times.

### BACKGROUND OF THE INVENTION

Many sporting events involve races where the time required for an athlete to cover a specified distance or successive distances is measured, displayed, recorded, and stored. Trainers work with athletes regularly with hope of helping them perform better and achieve the best outcome possible. As with many sports, swimming is a familiar example where practices and training sessions play critical roles in preparing athletes to compete effectively during a competition.

Trainers rely on routine training programs, called “benchmark sets,” implemented over a season, year, or career in order to determine and evaluate progress for each athlete. Such longitudinal data provides trainers and athletes valuable information allowing them to develop athlete-specific training plan. Often, in swimming, elapsed times required for a swimmer to reach the 100 meter (“m”) mark, 200 m mark, 300 m mark, 400 m mark, and so on are measured using a traditional stopwatch worn around one's neck.

A trainer assigns a set of swimmers into a first group, or commonly called “heat” in swimming industry; another set of swimmers into a second heat; and so on. It is not uncommon to have up to six swimmers in a single heat. During training sessions, heat 1 swimmers begin to swim. Shortly thereafter, heat 2 swimmers will follow heat 1 swimmers, and so on until all swimmers are in the water swimming. As heat 1 swimmers approach their first 100 m mark, a trainer shouts each of the six swimmers' elapsed time as they complete their first repetition, all of which occurs in a matter of split seconds. Immediately thereafter, heat 2 swimmers complete their first 100 m mark forcing a trainer to once again shout each of the six swimmers' elapsed times. This process continues for each swimmer, for each heat, and for each specified distances covered (in swimming, the norm is four to ten repetitions). These times are shouted out to swimmers to communicate their performance as well as to have each swimmer try to remember their elapsed times to be recorded after a training session.

For advanced athletes, such as collegiate swimmers, a trainer also monitors heartbeat rates and a number of strokes as these “body count” data provides additional information for better understanding athletes' performance. At a predetermined distance specified by a trainer, but while resting in between repetitions, athletes check their heartbeat rates and write them down on a transparency film using a waterproof sharpie. In other words, in the middle of a training session, athletes' heartbeat rates are measured and recorded. With respect to “stroke counts,” a trainer or an assistant targets one athlete and physically counts the number of strokes taken to cover a predetermined distance. This information is written down on a paper or a mental note is made. Depending on a trainer, these information remain as physical copies to be stored away in a filing cabinet (to be retrieved when needed) or are entered into a spreadsheet at a later time.

In addition to traditional benchmark sets, trainers training advanced athletes use rigorous training programs called “Power Tower” sets. Power Tower sets differ from traditional benchmark sets in that additional athlete-specific data is recorded. These athletes are given specific task to focus on either swimming or kicking, provided with weights, or equipped with a gear or a combination of gears. Therefore, swimmers participating in the same repetitions will differ based on their individually chosen factors. For example, swimmer one will focus on swimming using 5 lbs of weight without the use of any gear while swimmer two who performs the same repetition as swimmer one will focus on underwater kicking using 1 kg of weight with the use of a snorkel and fins. Presently, there is no systematical method of tracking this information other than what is recorded on paper.

Unfortunately, an enormous amount of time is spent after a training session to manage training data. At the end of a training session, these elapsed times, body count, and power tower data are written on a sheet of paper with a goal of entering them into a spreadsheet for data manipulation, analyses, and email communication. Such delay in data entry makes recall more challenging and further delay communication of results and reports to swimmers. Sometimes, there is a confusion regarding whose time belongs to whom; sometimes, a trainer forgets the precise time. Such process is prone to errors and is very inefficient. Moreover, for each training session, a typical swimming coach of a swimming club spends approximately ten hours working on data entry, data analyses, data reporting, and email communication.

In an environment where additional resources are available, a volunteer or an assistant records athletes' elapsed times at the site using pencil and paper. Though some problems associated with “shouting” are alleviated with this approach, it does not address the delay in communication or manual data entry. In the context of training advanced athletes, there is currently no systematical approach to recording body count or power tower sets (i.e., athlete-specific data associated with advanced benchmark sets). In collegiate swimming, for example, a typical swimming coach and assistant spend approximately six hours working on data entry, searching for historical data, data analyses, data reporting, and email communication per training session.

Demands for measuring, displaying, recording, and storing elapsed times for athletes clustered into groups regulated by automated or manual starting times and having different stopping times such as at swimming training sessions and the like have resulted in a need to develop a sophisticated method and system for assisting trainers efficiently and effectively capture athletes' elapsed times, as well as athlete-specific data. Although there is a desire among trainers to perform additional training more frequently, the manual-intensive nature of the task and its associated costs, both financial and non-financial, currently prevent them from doing so or they do not record data but instead rely on “gut” instincts to understand their athletes.

Technologies for managing and presenting sporting event information are known in the art. For example, U.S. Pat. No. 4,797,864 to Stano et al. discloses a timekeeping apparatus for measuring multiple intervals of time. However, Stano et al. do not provide a cost-effective method and system of measuring, displaying, recording, and storing elapsed times taken on a real-time basis for each athlete to complete predetermined distances or repetitions having multiple athletes within a heat who have common starting time and different stopping times with each heat having different starting times.

US Patent Publication No. 2012/0120771 A1 to Lapides discloses a method and system for presenting and teaching comparative timing data to the audience of a sport. However, Lapides does not gather training times or provide a cost-effective method and system of measuring, displaying, recording, and storing elapsed times taken on a real-time basis for each athlete to complete predetermined distances or repetitions having multiple athletes within a heat who have common starting time and different stopping times with each heat having different starting times.

US Patent Publication No. 2012/0082007 A1 to Duxbury discloses a timing apparatus for calculating elapsed time of movement of the runners and their finishing order based on detected signals. However, Duxbury does not gather training times or provide a cost-effective method and system of measuring, displaying, recording, and storing elapsed times taken on a real-time basis for each athlete to complete predetermined distances or repetitions having multiple athletes within a heat who have common starting time and different stopping times with each heat having different starting times.

U.S. Pat. No. 4,505,595 to Rose et al. discloses a dual timing stopwatch incorporating a sensor-triggered primary timer and a manually-triggered secondary timer. However, Rose et al. do not gather training times or provide a cost-effective method and system of measuring, displaying, recording, and storing elapsed times taken on a real-time basis for each athlete to complete predetermined distances or repetitions having multiple athletes within a heat who have common starting time and different stopping times with each heat having different starting times.

US Patent Publication No. 2009/0213700 A1 to Conant discloses an automated interval timing method device and system for automatically capturing elapsed times by wearing a timing device. However, Conant does not gather training times or provide a cost-effective method and system of measuring, displaying, recording, and storing elapsed times taken on a real-time basis for each athlete to complete predetermined distances or repetitions having multiple athletes within a heat who have common starting time and different stopping times with each heat having different starting times.

U.S. Pat. No. 5,229,981 to Maschi discloses a multi-event timer that allows a user to make successive interval measurements. However, Maschi does not gather training times or provide a cost-effective method and system of measuring, displaying, recording, and storing elapsed times taken on a real-time basis for each athlete to complete predetermined distances or repetitions having multiple athletes within a heat who have common starting time and different stopping times with each heat having different starting times.

Athletes train on a regular basis throughout a year, and trainers use benchmark sets to evaluate progress, motivate athletes, and track performance. Benchmark sets are predetermined training templates that a trainer implements many times a season, year, or career, and one that allows him or her to track progress of each athlete over a period of time. Currently, a trainer (1) relies on paper-and-pencil to record each athlete's elapsed times, (2) relies on his or her memory so that elapsed times can be recorded at a later time, (3) shouts out hoping that each athlete will remember his or her elapsed times so that they can be recorded at a later time, (4) manually enters elapsed times into a spreadsheet, (5) delays his or her communication back to athletes, and (6) spends an enormous amount of time managing training data. In training advanced athletes, a trainer is further challenged to record and manage athlete-specific information such as heartbeat rate, stroke count, swimming type, weight, or equipment. Clearly, all of the methods are ineffective, inefficient, and prone to inaccuracies. It is desirable to be able to measure, display, record, and store athletes' elapsed times on a real-time basis using an electronic device, preferably a mobile device while at the site (e.g., pool deck, track field). It is also desirable to be able to record and store athlete-specific information such as heartbeat rate, stroke count, or power tower data. It is therefore desired to provide a cost-effective method and system which addresses these deficiencies or at least provide an effective or useful alternative to the prior art.

### SUMMARY OF THE INVENTION

A need exists to provide a cost-effective method and system in which elapsed times are measured for training athletes involved in performing multiple repetitions. Such matrix-based timer method and system would prove useful for measuring, displaying, recording, and storing elapsed times having multiple athletes within a heat where each heat has common starting times and different stopping times. It is appropriate to use mobile communication devices since portability is an important consideration in one's ability to perform a task at the site. Therefore, it would be useful to be able to provide a sophisticated method and system that measure, display, record, and store each swimmer's elapsed time for each repetition such that the maximum number of “clicks” a trainer needs to perform on a mobile communication device is also the minimum number of “clicks” required. In an example of six lanes with four heats (or 24 swimmers) having six repetitions: start timer (1)+total number of swimmers (24)*six repetitions (6), or 1+24*6=145 clicks. Ideally, a “click” is a voice activated mechanism in which the use of a wired or wireless technology serves to measure, display, record, and store elapsed times. The total amount of post-training time spent by trainers would be down to a minimum while improving data integrity, reliability, feedback, and communication.

Accordingly, it is an object of the present invention to provide a method and system for measuring, displaying, recording, and storing elapsed times taken on a real-time basis to cover a distance, successive predetermined distances, repetitions, or activities among athletes belonging to a heat where athletes in each heat have common starting time and different stopping times with each heat having different starting times. It is another object of the present invention to provide a method and system for recording and storing body count and power tower information. It is another object of the present invention to provide a software application integrating athlete, benchmark set, elapsed time, body count, and power tower data into meaningful information.

These and other objectives are achieved by providing a method and system of presenting to a trainer athletes data, benchmark sets data (i.e., repetition, repetition cycle, rest cycle time, and base interval time), groups (heats), and timers for measuring, displaying, recording, and storing elapsed times of each athlete for each of his or her repetitions.

Another objective of this method and system is that it is easy to assign athletes to a heat and a lane, select benchmark sets, record body count information, record power tower data, and use for recording and storing elapsed times, and is affordable.

Another objective of this method and system is that it is easy to create athlete profiles, develop benchmark sets, analyze elapsed times, and manage body count and power tower data.

Another objective of this method and system is to conduct training sessions that starts heat-level timers based on repetition cycle, rest cycle time, base interval time, and heat position.

Another objective of this method and system is to conduct training sessions that manually starts heat-level timers.

Another objective of this method and system is to measure and display total duration of an overall training session through the use of a global timer.

Another objective of this method and system is to provide a method to start, pause, or reset for managing global and heat timers.

Another objective of this method and system is to perform mathematical calculations and display its results using elapsed time data. Average and total computations serve as examples.

Another objective of this method and system is to provide a method for navigating between one heat to another heat. Switch, show/hide, and slide are few examples.

Another objective of this method and system is to provide a method for displaying one or more repetitions. Switch, show/hide, and scrolling are few examples.

Another objective of this method and system is to upload elapsed times, body count, and power tower data and download athlete, benchmark sets, and historical elapsed times, body count, and power tower data to/from a storage location such as a database.

In some embodiments, the display of elapsed times provide intervals of time preferably in minutes, seconds, and hundredth of seconds, each of which ideally displays two digits.

In some embodiments, this method and system supports one athlete, one repetition, or one heat, or as many athletes, repetitions, or heats as mobile communication devices allow.

In some embodiments, the software application of this invention running on personal or mobile communication devices displays athlete and benchmark sets data and measures, displays, records, and stores elapsed times through mouse-click, keyboard-click, screen-touch, or voice-activated command.

In some embodiments, the software application of this invention running on personal or mobile communication devices performs data analyses, reporting, or email or text communication.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

FIG. 1 illustrates a typical manner in which athletes in different lanes belonging to a heat conduct their training, and a trainer who measures, records, and stores elapsed times, body count, or power tower data.

FIG. 2A is a flow chart illustrating a method according to the invention.

FIG. 2B is a flow chart illustrating a method according to the invention.

FIG. 3 is a block diagram illustrating an example system according to the invention.

FIG. 4A is an illustration of an example software application according to the invention.

FIG. 4B is an illustration of an example software application according to the invention.

FIG. 5 is an illustration of an example software application according to the invention.

FIG. 6 is an illustration of an example software application according to the invention.

### DETAILED DESCRIPTION OF THE INVENTION

For the purposes of this disclosure, a trainer includes coaches, assistant coaches, helpers, volunteers, or any other interested parties at the site of a training session.

For the purposes of this disclosure, a mobile communication device includes a mobile device of any type including devices currently known as “smartphones”, “cellular phones”, iPhone™ personal digital devices (“PDA(s)”), iPad™, and/or laptop or tablet computer, all of which are portable and may operate on a cellular network, the internet, or through a proprietary network, or any other suitable portable computing device or network.

For the purposes of this disclosure, a personal communication device includes a computer, laptop, or tablet computer, all of which may operate on a cellular network, the internet, or through a proprietary network, or any other suitable computing device or network.

For the purposes of this disclosure, the term “repetition” is to be understood as meaning a distance and type of activity; “repetition cycle” is to be understood as meaning a total number of repetitions to be performed; “rest cycle time” is to be understood as meaning a time allowed for an athlete to complete a repetition; “heat” is to be understood as meaning a group to which athletes are assigned; “base interval time” is to be understood as meaning a duration between the beginning of one heat and the beginning of next heat; “benchmark set” is to be understood as meaning a pre-defined training program comprising of repetition, repetition cycle, rest cycle time, and base interval time; “power tower” is to be understood as meaning a special type of a benchmark set requiring athlete-specific training information to be specified including weight, equipment, or type of swimming; and “body count” is to be understood as meaning an athlete-specific set of information pertaining to athlete's bodily activity including heartbeat rate and stroke count. The underlying concepts and terminologies used in other sporting events, such as cross-country, track and field, football, auto races, relay races and the like, are similar.

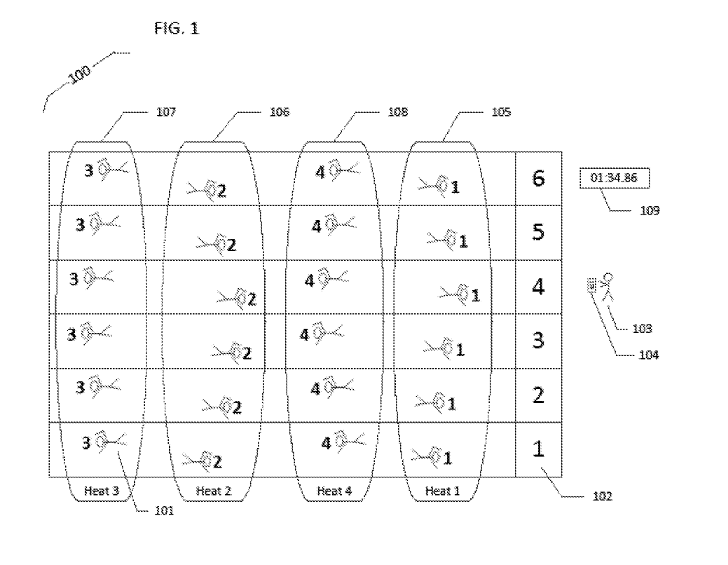

FIG. 1 illustrates a training session example 100 where athletes 101 in different lanes 102 are grouped into “heats” and a trainer 103 is at the site to measure and record elapsed times using a mobile communication device 104.

By way of example only, using six lanes in a typical 50 meter (“m”) swimming pool, it is not uncommon to find a coach-to-swimmer ratio at about 1-to-24 during a training session. This often translates into four swimmers per lane where the first set of swimmers from each lane comprise of “Heat 1” 105, second set “Heat 2” 106, third set “Heat 3” 107, and fourth set “Heat 4” 108. As a set of swimmers completes their repetition, a trainer 103 uses a mobile communication device 104 to measure, display, record, and store an elapsed time of each swimmer for each repetition completed. Swimmers use a pool clock 109 to determine when to begin the next repetition based upon which heat he or she belongs to and the pre-determined rest cycle time.

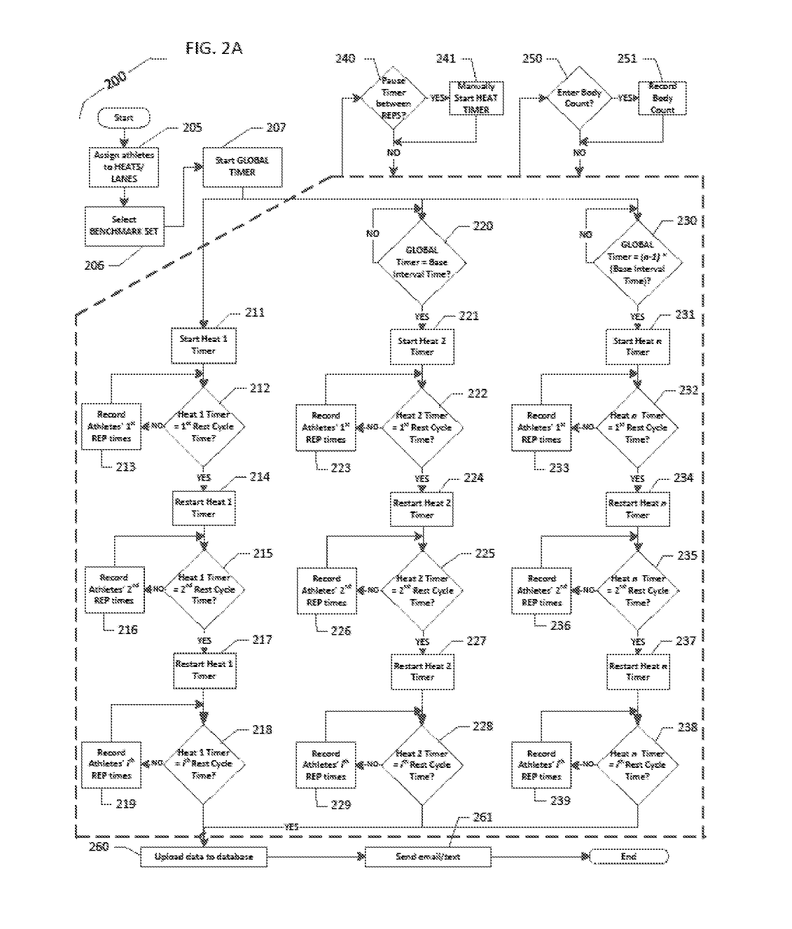

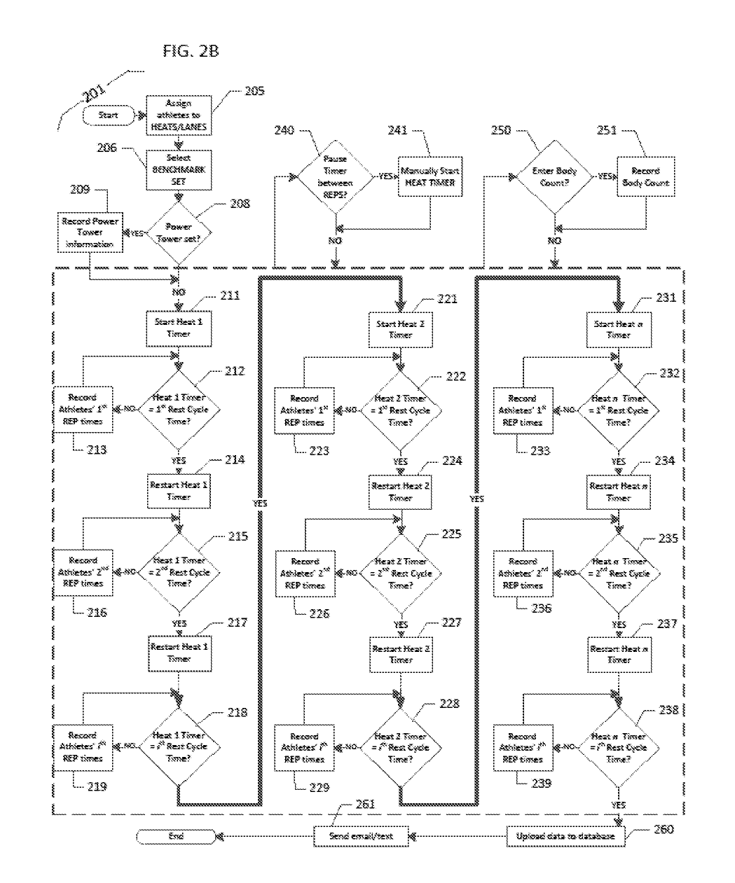

FIG. 2A illustrates an example method 200 according to the invention, where heat timers are automatically started, a trainer initiates and prepares for a training session, a trainer measures, displays, records, and stores elapsed times of each athlete for each repetition completed, a trainer records and stores body count information, and all athletes are training concurrently.

It becomes necessary for a trainer to have access to athletes' roster because some may not attend a training session. For those attending, a trainer assigns each athlete to a particular Heat and Lane 205 according to his or her performance—fastest athletes are usually assigned to Heat 1 while the slowest are assigned to the last heat. This is to prevent athletes from swimming past those athletes in the heat ahead of them.

Once athletes are assigned to their respective heat and lane, a trainer selects a Benchmark Set 206 among the many available pre-defined Benchmark Set templates. A 6×100 m Freestyle Benchmark Set at 1:30 rest cycle time with 5 second base interval time is a familiar example representing six repetitions of 100 m Freestyle stroke with 1 minute and 30 seconds to complete each repetition. Therefore, a total of 600 m of swimming occurs with six measurements of elapsed times recorded for each swimmer all of which is performed in approximately nine minutes.

After all athletes are lined up, a trainer starts a global timer 207 which automatically starts Heat 1 timer 211, and athletes in Heat 1 begin their first repetition. After a base interval time 220 has lapsed, Heat 2 timer 221 automatically begins and athletes in Heat 2 begin their first repetition trailing behind Heat 1 athletes. This process continues until all athletes in Heat n (where n=3, 4, 5, . . . n) begin their first repetition: after n−1* “base interval time” 230 (or base interval time lapsed after Heat n−1 timer begins), Heat n timer 231 automatically begins and athletes in Heat n begin their first repetition.

As first athlete from Heat 1 completes his or her first repetition, a trainer records his or her elapsed time 213. As second athlete from Heat 1 completes his or her first repetition, a trainer records his or her elapsed time 213. This process continues for all athletes in Heat 1. In the meantime, all athletes from Heat 1 who completed their first repetition rest and monitor the pool clock until Heat 1 timer equals first repetition rest cycle time 212 at which point Heat 1 timer 214 automatically restarts from zero and all athletes from Heat 1 begin their second repetition. In a similar manner as in the first repetition, a trainer records athletes' elapsed times 216 at the completion of their second repetition and athletes wait until Heat 1 timer equals second repetition rest cycle time 215 at which point Heat 1 timer 217 automatically restarts from zero and all athletes from Heat 1 begin their third repetition. This process continues in a similar manner while athletes are working on their repetition i 218 (where i=3, 4, 5, . . . i) until a trainer records athletes' elapsed times 219 at the completion of their i^{th} repetition. This concludes Heat 1 training session.

For each repetition, trailing behind Heat 1 athletes are Heat 2 athletes. As first athlete from Heat 2 completes his or her first repetition, a trainer records his or her elapsed time 223. As second athlete from Heat 2 completes his or her first repetition, a trainer records his or her elapsed time 223. This process continues for all athletes in Heat 2. In the meantime, all athletes from Heat 2 who completed their first repetition rest and monitor the pool clock until Heat 2 timer equals first repetition rest cycle time 222 at which point Heat 2 timer 224 automatically restarts from zero and all athletes from Heat 2 begin their second repetition. In a similar manner as in the first repetition, a trainer records athletes' elapsed times 226 at the completion of their second repetition and athletes wait until Heat 2 timer equals second repetition rest cycle time 225 at which point Heat 2 timer 227 automatically restarts from zero and all athletes from Heat 2 begin their third repetition. This process continues in a similar manner while athletes are working on their repetition i 228 (where i=3, 4, 5, . . . i) until a trainer records athletes' elapsed times 229 at the completion of their i^{th} repetition. This concludes Heat 2 training session.

For each repetition, trailing behind Heat n−1 athletes are Heat n athletes (where n=3, 4, 5, . . . n). As first athlete from Heat n completes his or her first repetition, a trainer records his or her elapsed time 233. As second athlete from Heat n completes his or her first repetition, a trainer records his or her elapsed time 233. This process continues for all athletes in Heat n. In the meantime, all athletes from Heat n who completed their first repetition rest and monitor the pool clock until Heat n timer equals first repetition rest cycle time 232 at which point Heat n timer 234 automatically restarts from zero and all athletes from Heat n begin their second repetition. In a similar manner as in the first repetition, a trainer records athletes' elapsed times 236 at the completion of their second repetition and athletes wait until Heat n timer equals second repetition rest cycle time 235 at which point Heat n timer 237 automatically restarts from zero and all athletes from Heat n begin their third repetition. This process continues in a similar manner while athletes are working on their repetition i 238 (where i=3, 4, 5, . . . i) until a trainer records athletes' elapsed times 239 at the completion of their i^{th} repetition. This concludes Heat n training session.

During a training session, a trainer may find a need to delay the start of next repetition. In between completion of a repetition and start of next repetition, a trainer pauses the heat timer 240 allowing athletes to take a longer rest. When ready, a trainer manually restarts the heat timer 241 at which point athletes continue with next repetition.

For advanced athletes, such as collegiate swimming, a trainer records body count information 250. Athletes measure their heartbeat rate after a predetermined distance or repetition—e.g., measure heartbeat rate after third repetition. It is not necessary to pause a timer as each athlete takes about 10 seconds to measure his or her heartbeat—plenty of time before the start of next repetition. Instead of writing it down, heartbeat rate 251 is recorded into the system for each athlete. Similarly, a trainer observes a swimmer during a repetition and records stroke count 251.

With limited display space on mobile communication devices, one way for heats to be organized is by pages or screens. Automatically changing to next heat page or screen is performed after current heat's last athlete has completed his or her repetition; alternatively, a trainer manually navigates between heat pages or screens.

After completing a training session, as network connectivity allows, stored elapsed times or body count data is automatically uploaded to a storage device 260 such as a database and an email or text 261 is automatically sent to trainers, athletes, parents, and/or other interested parties informing them regarding availability of athletes' training elapsed time data.

While automatically initiating heat timers is desirable, there are several training programs that require a trainer to manually start, pause, or reset timers. FIG. 2B illustrates an example method 201 according to the invention, where heat timers are manually started, a trainer initiates and prepares for a training session, a trainer measures, records, and stores elapsed times of each athlete for each repetition completed, a trainer records and stores athlete-specific data, and athletes from a heat are measured one heat at a time.

It becomes necessary for a trainer to have access to athletes' roster because they may or may not attend a training session. For those attending, a trainer assigns each athlete to a particular Heat and Lane 205.

Once athletes are assigned to their respective heat and lane, a trainer selects a Benchmark Set 206 among the many available pre-defined Benchmark Set templates. A 6×100 m IM Benchmark Set at varied rest cycle time is a familiar example representing six repetitions as follows: Repetition 1, 100 m Freestyle stroke with 1 minute and 30 seconds rest cycle time; Repetition 2, 100 m Butterfly stroke with 2 minute and 00 seconds rest cycle time; Repetition 3, 100 m Freestyle stroke with 1 minute and 45 seconds rest cycle time; Repetition 4, 100 m Breast stroke with 2 minute and 30 seconds rest cycle time; Repetition 5, 100 m Freestyle stroke with 1 minute and 45 seconds rest cycle time; and Repetition 6, 100 m Back stroke with 1 minute and 45 seconds rest cycle time. Therefore, a total of 600 m of swimming occurs with six measurements of elapsed times recorded for each swimmer all of which is performed within a 11 minutes and 15 seconds period.

For more rigorous training programs, or “Power Tower” sets 208, a trainer is provided the ability to record athlete-specific Power Tower information 209 including swimming type, weights, or equipment.

After all athletes are lined up, a trainer starts Heat 1 timer 211 and athletes in Heat 1 begin their first repetition. As first athlete from Heat 1 completes his or her first repetition, a trainer records his or her elapsed time 213. As second athlete from Heat 1 completes his or her first repetition, a trainer records his or her elapsed time 213. This process continues for all athletes in Heat 1. In the meantime, all athletes from Heat 1 who completed their first repetition rest and monitor the pool clock until Heat 1 timer equals first repetition rest cycle time 212 at which point Heat 1 timer 214 automatically restarts from zero and all athletes from Heat 1 begin their second repetition. In a similar manner as in the first repetition, a trainer records athletes' elapsed times 216 at the completion of their second repetition and athletes wait until Heat 1 timer equals second repetition rest cycle time 215 at which point Heat 1 timer 217 automatically restarts from zero and all athletes from Heat 1 begin their third repetition. This process continues in a similar manner while athletes are working on their repetition i 218 (where i=3, 4, 5, . . . i) until a trainer records athletes' elapsed times 219 at the completion of their i^{th} repetition. The last athlete to complete the i^{th} repetition concludes Heat 1 training session.

After concluding Heat 1 training session, a trainer starts Heat 2 timer 221 and athletes in Heat 2 begin their first repetition. As first athlete from Heat 2 completes his or her first repetition, a trainer records his or her elapsed time 223. As second athlete from Heat 2 completes his or her first repetition, a trainer records his or her elapsed time 223. This process continues for all athletes in Heat 2. In the meantime, all athletes from Heat 2 who completed their first repetition rest and monitor the pool clock until Heat 2 timer equals first repetition rest cycle time 222 at which point Heat 2 timer 224 automatically restarts from zero and all athletes from Heat 2 begin their second repetition. In a similar manner as in the first repetition, a trainer records athletes' elapsed times 226 at the completion of their second repetition and athletes wait until Heat 2 timer equals second repetition rest cycle time 225 at which point Heat 2 timer 227 automatically restarts from zero and all athletes from Heat 2 begin their third repetition. This process continues in a similar manner while athletes are working on their repetition i 228 (where i=3, 4, 5, . . . i) until a trainer records athletes' elapsed times 229 at the completion of their i^{th} repetition. The last athlete to complete the i^{th} repetition concludes Heat 2 training session.

This process continues until the final Heat n (where n=3, 4, 5, . . . n). After Heat n−1 training session, a trainer starts Heat n timer 231 and athletes in Heat n begin their first repetition. As first athlete from Heat n completes his or her first repetition, a trainer records his or her elapsed time 233. As second athlete from Heat n completes his or her first repetition, a trainer records his or her elapsed time 233. This process continues for all athletes in Heat n. In the meantime, all athletes from Heat n who completed their first repetition rest and monitor the pool clock until Heat n timer equals first repetition rest cycle time 232 at which point Heat n timer 234 automatically restarts from zero and all athletes from Heat n begin their second repetition. In a similar manner as in the first repetition, a trainer records athletes' elapsed times 236 at the completion of their second repetition and athletes wait until Heat n timer equals second repetition rest cycle time 235 at which point Heat n timer 237 automatically restarts from zero and all athletes from Heat n begin their third repetition. This process continues in a similar manner while athletes are working on their repetition i 238 (where i=3, 4, 5, . . . i) until a trainer records athletes' elapsed times 239 at the completion of their i^{th} repetition. The last athlete to complete the i^{th} repetition concludes Heat n training session.

During a training session, a trainer may find a need to delay the start of next repetition. In between completion of a repetition and start of next repetition, a trainer pauses the heat timer 240 allowing athletes to take a longer rest. When ready, a trainer manually restarts the heat timer 241 at which point athletes continue with next repetition.

For advanced athletes, such as collegiate swimming, a trainer records body count information 250. Athletes measure their heartbeat rate after a predetermined distance or repetition—e.g., measure heartbeat rate after third repetition. It is not necessary to pause a timer as each athlete takes about 10 seconds to measure his or her heartbeat—plenty of time before the start of next repetition. Instead of writing it down, heartbeat rate 251 is recorded into the system for each athlete. Similarly, a trainer observes a swimmer during a repetition and records stroke count 251.

With limited display space on mobile communication devices, one way for heats to be organized is by pages or screens. Automatically changing to next heat page or screen is performed after concluding current heat's training session; alternatively, a trainer manually navigates to next heat page or screen.

After completing a training session, as network connectivity allows, stored elapsed times or body count data is automatically uploaded to a storage device 260 such as a database and an email or text 261 is automatically sent to trainers, athletes, parents, and/or other interested parties informing them regarding availability of athletes' training elapsed time data.

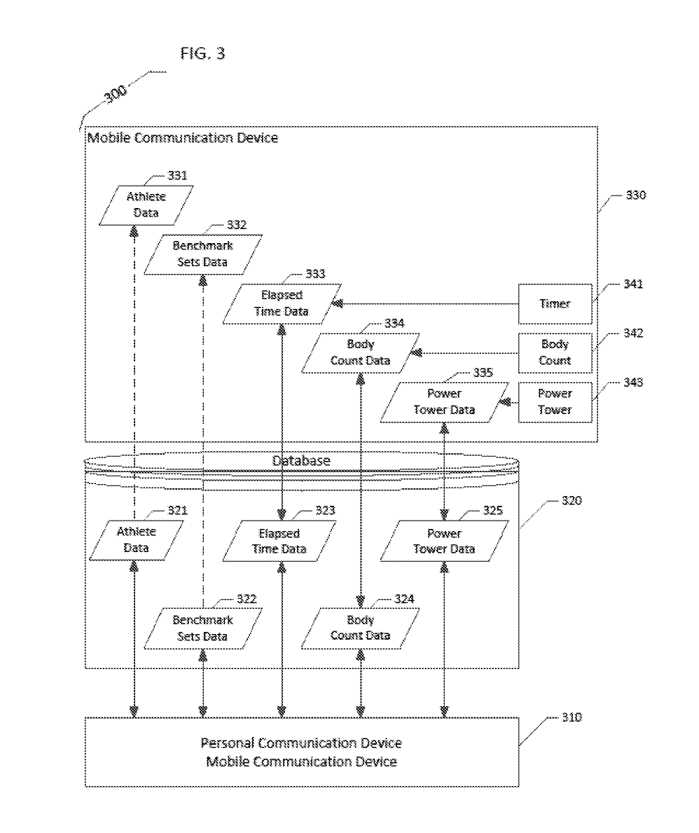

FIG. 3 illustrates an example system according to the invention. A personal or mobile communication device 310 stores, retrieves, creates, modifies, and deletes athlete data 321, benchmark sets data 322, elapsed time data 323, body count data 324, or power tower data 325 stored in a location 320 such as a database. A mobile communication device 330 used at the site uses athlete data 331 or benchmark sets data 332 by downloading and synchronizing, as needed, with respective data 321 and 322 from a storage location 320 such as a database. Using athlete data 331, attending athletes are displayed and selected to be assigned to a heat and a lane; using benchmark sets data 332, a specific benchmark set to be used during a training session is selected and displayed; a timer 341 measures, displays, records, and stores elapsed time data 333 for each athlete's repetition; a body count 342 displays, records, and stores body count data 334; and a power tower 343 displays, records, and stores power tower data 335. When network connectivity allows, stored elapsed time data 333, stored body count data 334, or stored power tower data 335 is automatically uploaded and added to its respective elapsed time data 323, body count data 324, or power tower data 325 in a storage location 320 such as a database where a personal or mobile communication device 310 is used to evaluate reports and perform other data manipulation and communication tasks.

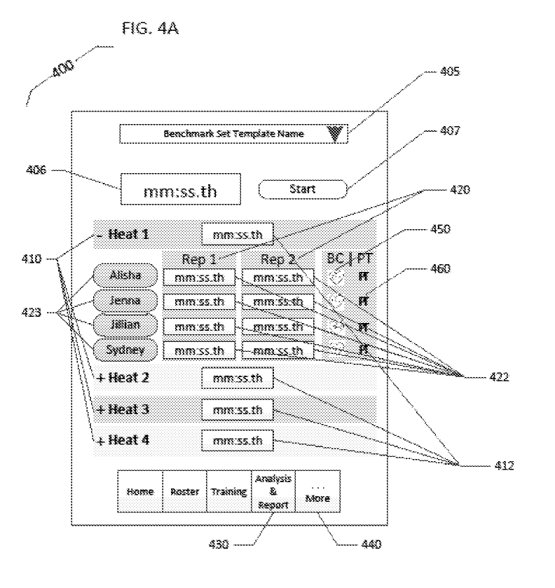

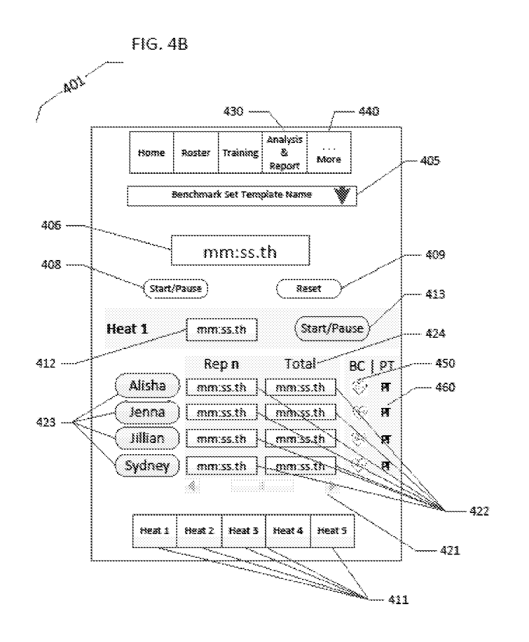

FIG. 4A and FIG. 4B illustrate two example dashboard software applications 400 and 401 according to the invention. The dashboard is most likely to operate on a mobile communication device as most athletic training sessions occur at the site like swimming pool, field, and tracks. The dashboard provides the user to select a benchmark set 405 which includes repetitions, repetition cycle, and rest cycle time. The dashboard displays a global timer 406 which measures the duration lapsed for the entire training session. The user is provided with start command 407, start/pause command 408, or reset command 409 to manipulate and manage the global timer.

Mobile communication devices typically have limited display space, so one example to overcome the challenge of displaying heat information is to utilize expand/collapse 410 or slide/change page or screen 411 concept. The user is also provided with a heat timer 412 and start/pause command 413. Show/hide 420 or scrolling 421 concept is an example of displaying repetition information along with elapsed times 422 associated with each athlete's repetitions. As each athlete completes his or her repetition, the user uses athlete timer stop command 423 or a voice-activated command to measure, display, record, and store athlete's repetition elapsed times. Once recorded, the application disables 423 such that the ability to re-record is not available.

There are other information of interest to trainers. Either as fixed “column(s)” or at the end of all repetitions, computational information 424 is displayed such as average, total, subtotal, best time, worst time, previous time, or lifetime best time. This set of information could prove useful since the user provides immediate feedback to the athletes. Alternatively, the user examines analysis and report 430 to access multiple reports that provide current, historical, and comparative elapsed times, body count, or power tower data at the individual, multi-individual, gender, or group level.

A trainer sends an email 440 following up with athletes, parents, or other interested parties about the training session.

In instances when athlete-specific data needs to be captured, a trainer accesses body count page or screen 450 to enter and record stroke count or heartbeat rate or power tower page or screen 460 to enter swimming type, weight, or equipment information.

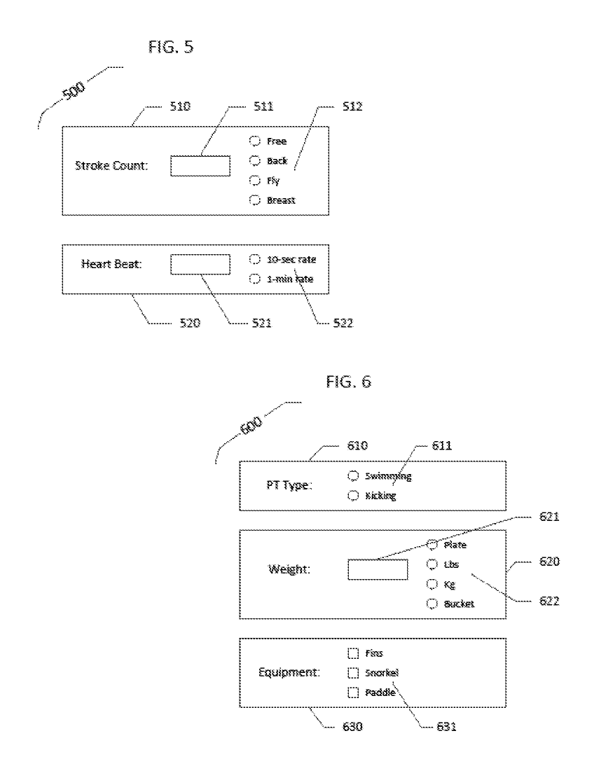

FIG. 5 illustrates an example software application 500 according to the invention. The sub-dashboard provides the user a stroke count area 510 to display, record, and store a total number of strokes 511 of a swimming stroke 512 taken to cover a predetermined distance as counted by a trainer. The user is also provided a heartbeat area 520 to enter and record a total number of heartbeats 521 with an indication of a heartbeat measurement method 522 of counting.

FIG. 6 illustrates an example software application 600 according to the invention. The sub-dashboard provides the user a power tower type area 610 to specify a swimming type 611 used to complete a power tower benchmark set. The user is also provided a weight area 620 to display, record, and store a total number of weights 621 with an indication of a weight measurement method 622 used. The user is provided an equipment area 630 to choose one or more equipment 631 used during a training session.

Those in the art should appreciate that the above-described invention helps minimize manual-intensive nature of work involved in collecting, organizing, analyzing, and communicating elapsed times and athlete-specific data while increasing data reliability, accuracy, quality, and timeliness. The use of mobile communication device makes it easy and cost-effective for all users.

Although the invention has been described with reference to a particular arrangement of parts, features, and the like, these are not intended to be exhaustive. It is recognized that those skilled in the art may make various modifications or additions or additions to the preferred embodiments chosen to illustrate the present invention without departing from the spirit and the scope of the present contribution to the art. For example, the time periods used may easily be changed to different periods such as days and hours or other intervals of time. Indeed, there are other possible arrangements or features as well as many modifications and variations that will be ascertainable to those of skill in the art.

What is claimed is:

1. A method of measuring, displaying, recording, and storing elapsed times taken on a real-time basis for each athlete to complete predetermined distances or repetitions having multiple athletes within a heat who have common starting time and different stopping times with each heat having different starting times, comprising the steps of:
assigning each athlete to a heat and a lane;
selecting a benchmark set;
starting a global timer to automatically start a heat one timer from zero to begin a heat one first repetition;
automatically starting a heat two timer from zero to begin a heat two first repetition after a base interval time has lapsed from start of said heat one timer;
for each subsequent heat first repetition thereafter, automatically starting a subsequent heat timer from zero to begin a subsequent heat first repetition after another said base interval time has lapsed from start of a previous heat timer;
measuring, displaying, and recording an elapsed time for each athlete at the end of his or her said heat one first repetition, said heat two first repetition, or said subsequent heat first repetition;
automatically storing the elapsed times in an electronic storage device;
automatically starting said heat one timer from zero to begin a heat one second repetition when said heat one timer is equal to a first repetition rest cycle time;
automatically starting said heat two timer from zero to begin a heat two second repetition when said heat two timer is equal to said first repetition rest cycle time;
for each subsequent heat thereafter, automatically starting a subsequent heat timer from zero to begin a subsequent heat second repetition when said subsequent heat timer is equal to said first repetition rest cycle time;
measuring, displaying, and recording an elapsed time for each athlete at the end of his or her said heat one second repetition, said heat two second repetition, or said subsequent heat second repetition;
automatically storing the elapsed times in said electronic storage device;
for each heat one subsequent repetition thereafter, automatically starting said heat one timer from zero to begin a heat one subsequent repetition when said heat one timer is equal to a previous repetition rest cycle time;
for each heat two subsequent repetition thereafter, automatically starting said heat two timer from zero to begin a heat two subsequent repetition when said heat two timer is equal to said previous repetition rest cycle time;
for each subsequent heat and each subsequent heat subsequent repetition thereafter, automatically starting a subsequent heat timer from zero to begin a subsequent heat subsequent repetition when said subsequent heat timer is equal to said previous repetition rest cycle time;
measuring, displaying, and recording an elapsed time for each athlete at the end of his or her said heat one subsequent repetition, said heat two subsequent repetition, or said subsequent heat subsequent repetition;
automatically storing the elapsed times in said electronic storage device;
automatically uploading the elapsed times to a database when network connection is or becomes available; and
automatically sending an email or a text to trainers, athletes, parents, or other interested parties informing them regarding availability of the elapsed times when network connection is or becomes available.

2. The method of claim 1, further comprising the steps of:
selecting a body count sub-dashboard;
displaying and recording a total number of strokes;
displaying and recording a swimming stroke corresponding to said total number of strokes;
displaying and recording a total number of heartbeats;
displaying and recording a heartbeat measurement method corresponding to said total number of heartbeats;
automatically storing said total number of strokes, said swimming stroke, said total number of heartbeats, or said heartbeat measurement method in said electronic storage device;
automatically uploading said total number of strokes, said swimming stroke, said total number of heartbeats, or said heartbeat measurement method to a database when network connection is or becomes available; and
automatically sending an email or a text to trainers, athletes, parents, or other interested parties informing them regarding availability of said total number of strokes, said swimming stroke, said total number of heartbeats, or said heartbeat measurement method when network connection is or becomes available.

3. The method of claim 1, further comprising the steps of:
pausing a heat timer after a repetition;
starting said heat timer; and
continuing with a subsequent repetition.

4. The method of claim 1, wherein a set of repetitions is displayed through display means including show/hide, switch, or scroll.

5. The method of claim 1, wherein a mathematical calculation, report, or graph using elapsed time data is displayed.

6. The method of claim 1, wherein a voice-activated means measure, display, record, and store said elapsed time.

7. A method of measuring, displaying, recording, and storing elapsed times taken on a real-time basis to complete predetermined distances or repetitions for each athlete belonging to a heat whereby all athletes train sequentially in the order of heats and all athletes within a heat have common starting time and different stopping times, comprising the steps of:
assigning each athlete to a heat and a lane;
selecting a benchmark set;
starting a heat one timer from zero to begin a heat one first repetition;
measuring, displaying, and recording an elapsed time for each athlete at the end of his or her said heat one first repetition;
automatically storing the elapsed times in an electronic storage device;
automatically starting said heat one timer from zero to begin a heat one second repetition when said heat one timer is equal to a first repetition rest cycle time;
measuring, displaying, and recording an elapsed time for each athlete at the end of his or her said heat one second repetition;
automatically storing the elapsed times in said electronic storage device;
for each subsequent repetition thereafter, automatically starting said heat one timer from zero to begin a heat one subsequent repetition when said heat one timer is equal to a previous repetition rest cycle time;
measuring, displaying, and recording an elapsed time for each athlete at the end of his or her said heat one subsequent repetition;
automatically storing the elapsed times in said electronic storage device;
starting a heat two timer from zero to begin a heat two first repetition;
measuring, displaying, and recording an elapsed time for each athlete at the end of his or her said heat two first repetition;
automatically storing the elapsed times in said electronic storage device;
automatically starting said heat two timer from zero to begin a heat two second repetition when said heat two timer is equal to said first repetition rest cycle time;
measuring, displaying, and recording an elapsed time for each athlete at the end of his or her said heat two second repetition;
automatically storing the elapsed times in said electronic storage device;
for each subsequent repetition thereafter, automatically starting said heat two timer from zero to begin a heat two subsequent repetition when said heat two timer is equal to a previous repetition rest cycle time;
measuring, displaying, and recording an elapsed time for each athlete at the end of his or her said heat two subsequent repetition;
automatically storing the elapsed times in said electronic storage device;
for each subsequent heat thereafter, starting a subsequent heat timer from zero to begin a subsequent heat first repetition;
measuring, displaying, and recording an elapsed time for each athlete at the end of his or her said subsequent heat first repetition;
automatically storing the elapsed times in said electronic storage device;
automatically starting said subsequent heat timer from zero to begin a subsequent heat second repetition when said subsequent heat timer is equal to said first repetition rest cycle time;
measuring, displaying, and recording an elapsed time for each athlete at the end of his or her said subsequent heat second repetition;
automatically storing the elapsed times in said electronic storage device;
for each subsequent repetition thereafter, automatically starting said subsequent heat timer from zero to begin a subsequent heat subsequent repetition when said subsequent heat timer is equal to a previous repetition rest cycle time;
measuring, displaying, and recording an elapsed time for each athlete at the end of his or her said subsequent heat subsequent repetition;
automatically storing the elapsed times in said electronic storage device;
automatically uploading the elapsed times to a database when network connection is or becomes available; and
automatically sending an email or a text to trainers, athletes, parents, or other interested parties informing them regarding availability of the elapsed times when network connection is or becomes available.

8. The method of claim 7, further comprising the steps of:
selecting a power tower sub-dashboard;
displaying and recording a swimming type;
displaying and recording a total number of weights;
displaying and recording a weight measurement method corresponding to said total number of weights;
displaying and recording an equipment including fins, snorkel, or paddle;
automatically storing said swimming type, said total number of weights, said weight measurement method, or said equipment in said electronic storage device;
automatically uploading said swimming type, said total number of weights, said weight measurement method, or said equipment to a database when network connection is or becomes available; and
automatically sending an email or a text to trainers, athletes, parents, or other interested parties informing them regarding availability of said swimming type, said total number of weights, said weight measurement method, or said equipment when network connection is or becomes available.

9. The method of claim 7, further comprising the steps of:
pausing a heat timer after a repetition;
starting said heat timer; and
continuing with a subsequent repetition.

10. The method of claim 7, further comprising the steps of:
selecting a body count sub-dashboard;
displaying and recording a total number of strokes;
displaying and recording a swimming stroke corresponding to said total number of strokes;
displaying and recording a total number of heartbeats;
displaying and recording a heartbeat measurement method corresponding to said total number of heartbeats;
automatically storing said total number of strokes, said swimming stroke, said total number of heartbeats, and said heartbeat measurement method in said electronic storage device;
automatically uploading said total number of strokes, said swimming stroke, said total number of heartbeats, or said heartbeat measurement method to a database when network connection is or becomes available; and
automatically sending an email or a text to trainers, athletes, parents, or other interested parties informing them regarding availability of said total number of strokes, said swimming stroke, said total number of heartbeats, or said heartbeat measurement method when network connection is or becomes available.

11. The method of claim 7, wherein a voice-activated means measure, display, record, and store said elapsed time.

12. The method of claim 7, wherein a set of repetitions is displayed through display means including show/hide, switch, or scroll.

13. The method of claim 7, wherein a mathematical calculation, report, or graph using elapsed time data is displayed.

14. A system for measuring, displaying, recording, and storing elapsed times taken on a real-time basis for each athlete to complete predetermined distances or repetitions having multiple athletes within a heat who have common starting time and different stopping times with each heat having different starting times, comprising:
a personal or mobile communication device creating, modifying, or deleting an athlete, a benchmark set, an elapsed time, a body count, or a power tower data;
a mobile communication device storing and displaying said athlete or said benchmark set data;
a mobile communication device measuring, displaying, recording, and storing athlete elapsed times for each repetition;
a mobile communication device displaying, recording, and storing a body count data; and
a mobile communication device displaying, recording, and storing a power tower data.

15. The system of claim 14, further comprising a database coupled, locally or networked, to said personal or mobile communication device; the database containing an athlete, a benchmark set, an elapsed time, a body count, or a power tower data.

16. The system of claim 14, further comprising a software application executing on said mobile communication device;
the software application measuring, displaying, recording, and storing athletes' elapsed times, displaying, recording, and storing body count and power tower data, and displaying athlete or benchmark set data.

17. The system of claim 14, further comprising a software application executing on said personal or mobile communication device; the software application creating, modifying, or deleting an athlete, a benchmark set, an elapsed time, a body count, or a power tower data.

18. The system of claim 14, wherein athlete data, benchmark set data, elapsed time data, body count data, or power tower data is associated with a particular athlete using a unique identifier.
